(19) United States
(12) Patent Application Publication
(10) Pub. No.: US 2026/0109186 A1
(43) Pub. Date: Apr. 23, 2026

(54) TIRE VALVE CAPABLE OF ENGAGING AND INFLATING AUTOMATICALLY

(71) Applicants: LUNG-KUO HSU, Changhua County (TW); CREATE FOREVER INDUSTRIAL CO., LTD., Changhua County (TW)

(72) Inventor: LUNG-KUO HSU, Changhua County (TW)

(21) Appl. No.: 18/922,621

(22) Filed: Oct. 22, 2024

(51) Int. Cl. B60C 29/06

(52) U.S. Cl. CPC B60C 29/064

(57) ABSTRACT

A tire valve is configured to inflate air into a tire via an inflation head, and the inflation head includes external threads, an internal diameter, and an external diameter. The tire valve contains a body with a first connection element and a second connection element. The first connection element includes an air feeding chamber, and the second connection element includes a connector, a stop ring, at least one movable retainer, and at least one return part. The connector includes a second fixing orifice, a conduit, and an air discharge chamber. The stop ring includes a through orifice, a second airtight sealing portion. The movable retainer is rotatably connected to the connector. The at least one return part is configured to abut against the movable retainer. The needle valve is received in the first connection element and the connector and includes a close portion, a post, and a locating rod.

### TECHNICAL FIELD

The present invention relates to a tire valve, and more particularly to the tire valve which is capable of engaging and inflating automatically.

### BACKGROUND

An inflation head is disposed on a vehicle's tire to inflate air into the tire after being connected with inflating equipment, wherein the inflating equipment has a tire valve configured to communicate with the inflation head, thus conducting the air. When connecting the tire valve with the inflation head, a fixing device on the tire valve is opened, then the tire valve is fitted with the inflation head, thereafter the fixing device is locked so that the tire valve is connected with the inflation head firmly, thus inflating the air. However, such an operation is troublesome, unsmooth, and complicated.

The tire valve of the vehicle cannot be closed automatically, conventional inflating equipment is classified as an air pump and an air compressor. When inflating the air by using the air compressor, the tire valve is connected with the inflation head first, then the tire valve is coupled with the air compressor. If the tire valve is connected with the air compressor first, an air leakage will occur from the valve tire, thus creating operational limitations and inconvenience.

A conventional tire valve is merely applicable for the inflation head with a valve core. In other words, the tire valve does not apply to the inflation head without the valve core, thus limiting quick and massive inflation and reducing the use of utility and function to dissatisfy user demands.

The present invention has arisen to mitigate and/or obviate the afore-described disadvantages.

### SUMMARY

The primary aspect of the present invention is to provide a tire valve capable of engaging and inflating automatically which is connected to an inflation head of a tire and is removed from the inflation head with one hand easily, when inflating/deflating the air into/from the tire (not shown); the tire valve is connected with the inflation head in an automatic engagement manner, thus inflating the air quickly and easily to save operation time and labor.

A further aspect of the present invention is to provide a tire valve capable of engaging and inflating automatically by which a close portion mates with an air feeding chamber to abut against an air block element so as to produce an airtight sealing effect, thus preventing an air leakage from the tire valve and enhancing a using convenience, when connecting the tire valve with the inflation head.

Another aspect of the present invention is to provide a tire valve capable of engaging and inflating automatically which is applicable for the inflation head with/without a valve core to inflate the air quickly and strongly.

To obtain above-mentioned aspects, a tire valve capable of engaging and inflating automatically provided by the present invention is configured to inflate air into a tire via an inflation head, the inflation head includes external threads formed on an outer wall of the inflation head, an internal diameter and an external diameter. The tire valve contains a body including a first connection element and a second connection element.

The first connection element includes an air feeding chamber, and the second connection element includes a connector, a stop ring, at least one movable retainer, and at least one return part.

The connector is connected with the first connection element, and the connector includes a second fixing orifice formed on a first end thereof, a conduit is defined between the second fixing orifice and the air feeding chamber, and an air discharge chamber is communicated with a channel. The conduit has a diameter, and the second fixing orifice is configured to accommodate the inflation head.

The stop ring is received in the channel and does not stop the channel, the stop ring includes a through orifice defined therein, and the stop ring also includes a second airtight sealing portion formed thereon and facing the second fixing orifice.

The movable retainer is rotatably connected with an end of the connector adjacent to the second fixing orifice, and the movable retainer includes a tooth portion formed on an inner wall thereof, and an actuation portion formed on an outer wall of the movable retainer. The tooth portion is controlled to move between an internal position and an internal position, the internal position is located in the second fixing orifice, and the external position is located outside the second fixing orifice and in the cavity.

The at least one return part is configured to abut against the movable retainer so that the tooth portion of the movable retainer is normally located in the internal position, and when controlling the actuation portion, the tooth portion of the movable retainer is moved to the external position.

The needle valve is received in the first connection element and the connector, the needle valve includes a close portion formed on a first end thereof, a post formed on a second end of the needle valve, and a locating rod defined between the close portion and the post. The post has a contact portion and a pushed portion which are formed on an end of the post away from the locating rod, the close portion is accommodated in the air feeding chamber, and an air block element is mounted between the close portion and the air feeding chamber, the close portion abuts against the air block element to close the conduit, the post is inserted through the air feeding chamber and channel and does not block the air feeding chamber and the channel. The locating rod is inserted through the conduit, and the close portion has a close portion diameter, the post has a post width, the contact portion has a contact portion width, and the locating rod has a locating rod diameter. The close portion diameter and the post width are greater than a conduit diameter, and the locating rod diameter is smaller than the conduit diameter so as to produce a limitation effect, the needle valve is limited to move between a closing position and an opening position. The width of the contact portion is smaller than the internal diameter of the inflation head.

### BRIEF DESCRIPTION OF THE DRAWINGS

FIG. 1 is a perspective view showing the assembly of a tire valve according to a preferred embodiment of the present invention.

FIG. 2 is a perspective view showing the exploded components of the tire valve according to the preferred embodiment of the present invention.

FIG. 3 is a side plan view showing the assembly of the tire valve according to the preferred embodiment of the present invention.

FIG. 4 is a cross-sectional view taken along the line A-A of FIG. 3.

FIG. 5 is a cross-sectional view showing the assembly of the first connection element of the tire valve according to the preferred embodiment of the present invention.

FIG. 6 is a cross-sectional view showing the assembly of the needle valve of the tire valve according to the preferred embodiment of the present invention.

FIG. 7 is a cross-sectional view showing the assembly of a part of the inflation head of the tire valve according to the preferred embodiment of the present invention.

FIG. 8 is a cross-sectional view showing the exploded component of the inflation head and the tire valve according to the preferred embodiment of the present invention.

FIG. 9 is a cross-sectional view showing the operation of the inflation head and the tire valve according to the preferred embodiment of the present invention.

FIG. 10 is another cross-sectional view showing the operation of the inflation head and the tire valve according to the preferred embodiment of the present invention.

FIG. 11 is also another cross-sectional view showing the operation of the inflation head and the tire valve according to the preferred embodiment of the present invention.

FIG. 12 is still another cross-sectional view showing the operation of the inflation head and the tire valve according to the preferred embodiment of the present invention.

FIG. 13 is another cross-sectional view showing the operation of the inflation head and the tire valve according to the preferred embodiment of the present invention.

FIG. 14 is also another cross-sectional view showing the operation of the inflation head and the tire valve according to the preferred embodiment of the present invention.

FIG. 15 is still another cross-sectional view showing the operation of the inflation head and the tire valve according to the preferred embodiment of the present invention.

FIG. 16 is a cross-sectional view showing the assembly of the needle valve of the tire valve according to another preferred embodiment of the present invention.

### DETAILED DESCRIPTION

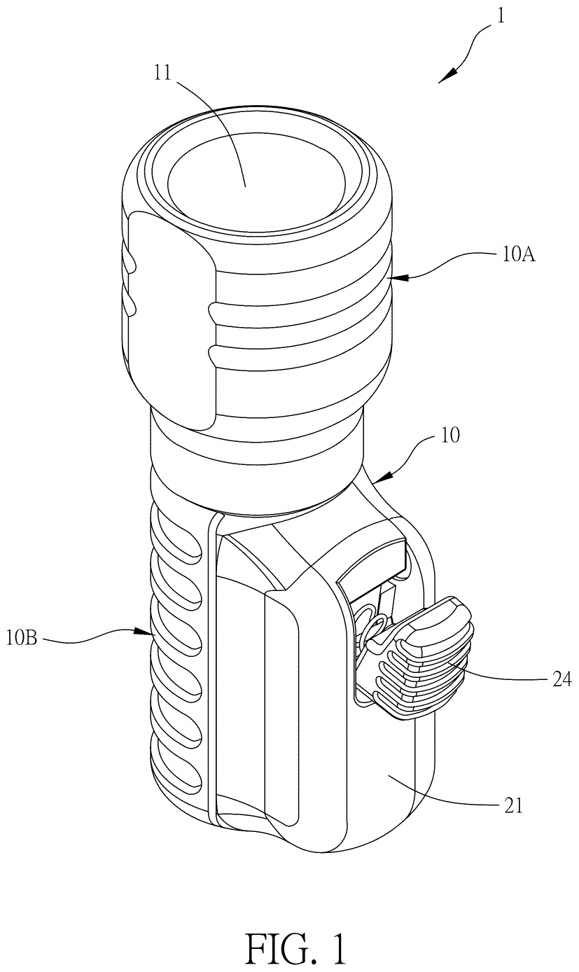

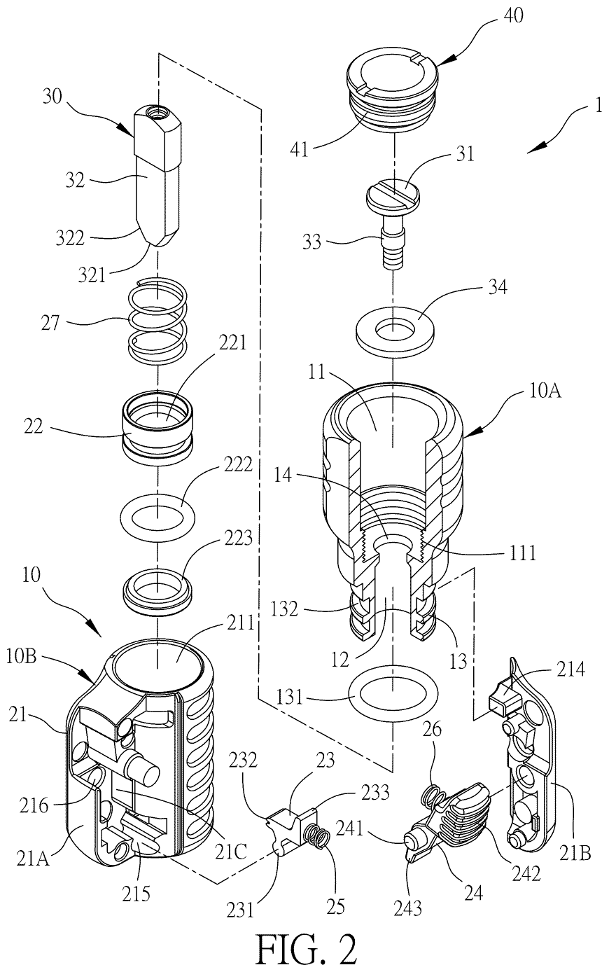

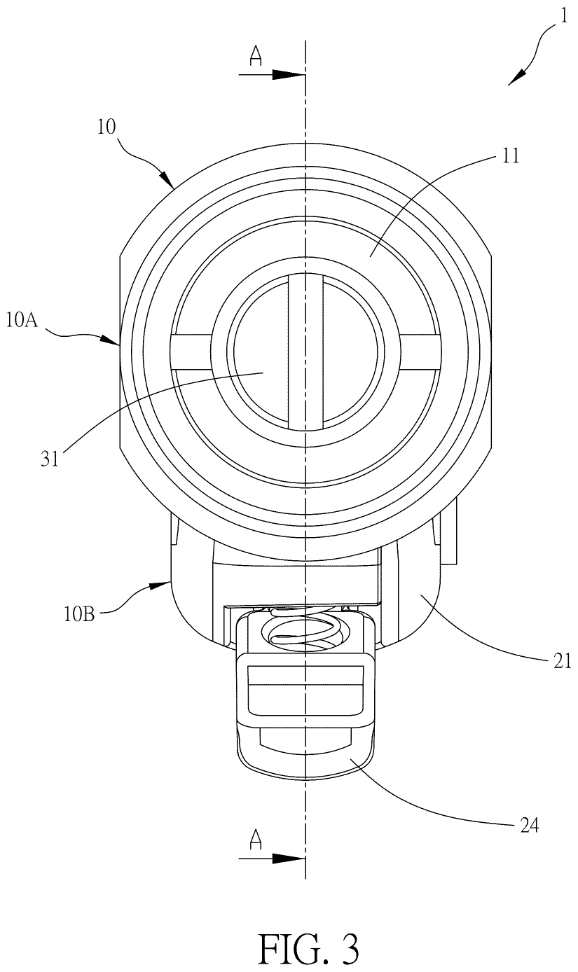

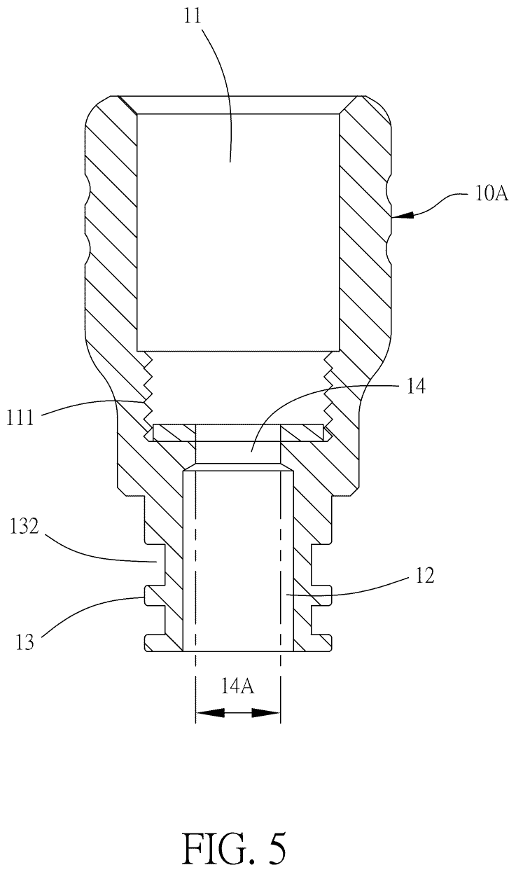

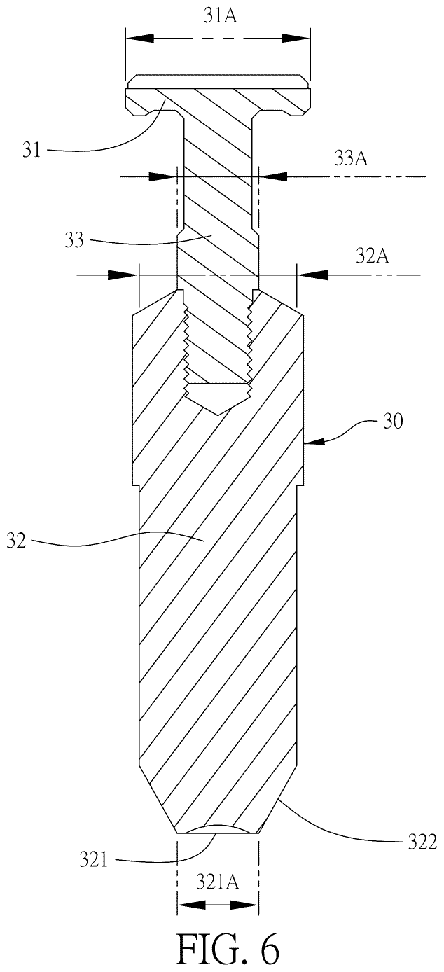

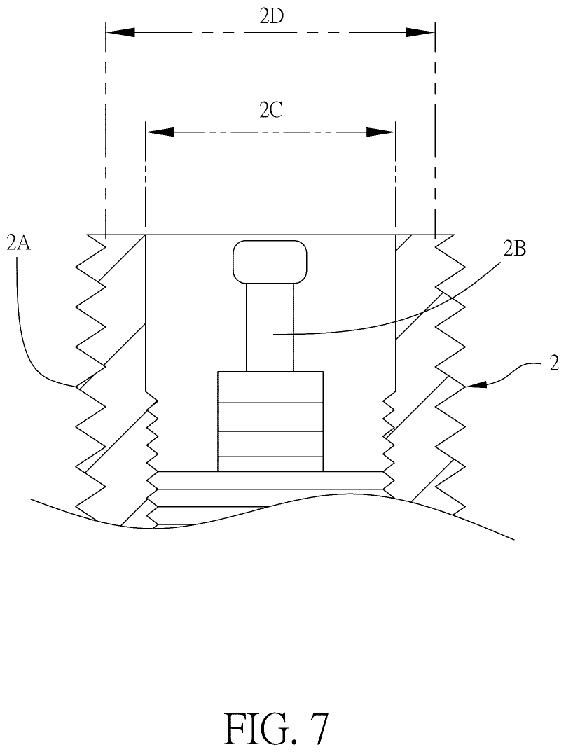

With reference to FIGS. 1-7, a tire valve 1 capable of engaging and inflating automatically according to a preferred embodiment of the present invention is configured to inflate air into a tire (not shown) via an inflation head 2, the inflation head 2 includes an external threads 2A formed on an outer wall thereof, a valve core 2B accommodated in the inflated head 2, an internal diameter 2C, and an external diameter 2D. The tire valve 1 includes a body 10, a needle valve 30, and an abutting ring 40.

The body 10 includes a first connection element 10A and a second connection element 10B.

The first connection element 10A includes an air feeding chamber 11 formed on a first end thereof, an air discharge chamber 12 and a coupling portion 13 which are defined on a second end of the first connection element 10A, a conduit 14 defined between the air feeding chamber 11 and the air discharge chamber 12, wherein a conduit diameter 14A of the conduit 14 is less than a diameter of the air feeding chamber 11 and a diameter of the air discharge chamber 12, and the air feeding chamber 11 has an inner threaded section 111 formed adjacent to the conduit 14, wherein the coupling portion 13 has an O ring 131 engaged on an outer wall thereof, and the coupling portion 13 also has a defining groove 132 formed in an annular shape and on the outer wall of the coupling element 13.

The second connection element 10B includes a connector 21, a stop ring 22, at least one movable retainer 23, at least one controlling part 24, at least one return part 25, 26, and a force spring 27.

The connector 21 includes a seat 21A, a cap 21B connected with the seat 21A, a cavity 21C defined between the seat 21A and the cap 21B, wherein the connector 21 includes a first fixing orifice 211 defined on a first end thereof, a second fixing orifice 212 formed on a second end of the connector 21, and a channel 213 defined between the first fixing orifice 211 and the second fixing orifice 212, and a protrusion 214 accommodated in the channel 213, such that the first fixing orifice 211 accommodates the coupling portion 13 of the first connection element 10A, and the second fixing orifice 212 receives the inflation head 2, an inner wall of the first fixing orifice 211 contacts with the O ring 131 of the coupling portion 13 to produce an airtight sealing effect. The protrusion 214 is engaged in the defining groove 132 of the coupling portion 13 so that the connector 21 is rotatable but is not removable with respect to the first connection element 10A. The cavity 21C is located beside the first fixing orifice 211, the second fixing orifice 212 and the channel 213, wherein the cavity 21C has a first rotatable connection portion 215 formed proximate to the first fixing orifice 212, and a third rotatable connection portion 216 formed adjacent to the channel 213.

The stop ring 22 is received in the channel 213 and does not stop the first fixing orifice 211 and the second fixing orifice 212, wherein the stop ring 22 is moved to the first fixing orifice 211 or the second fixing orifice 212 in the channel 213, the stop ring 22 includes a through orifice 221 defined therein, a first airtight sealing portion 222 formed on an outer wall thereof and abutting against the channel 213 to produce the airtight sealing effect. The stop ring 22 also includes a second airtight sealing portion 223 formed thereon and facing the second fixing orifice 212 to abut against the inflation head 2, thus producing the airtight sealing effect.

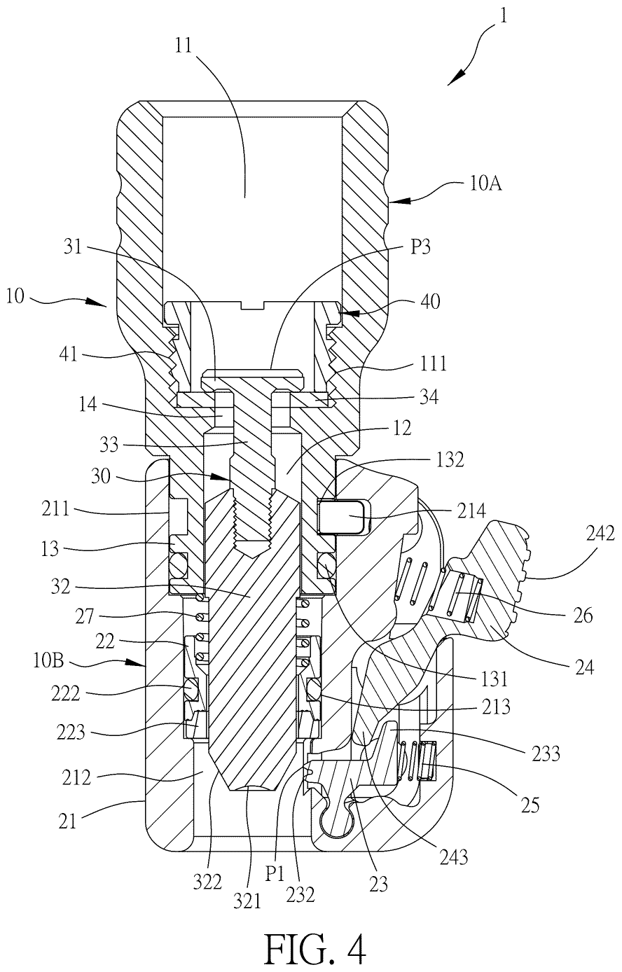

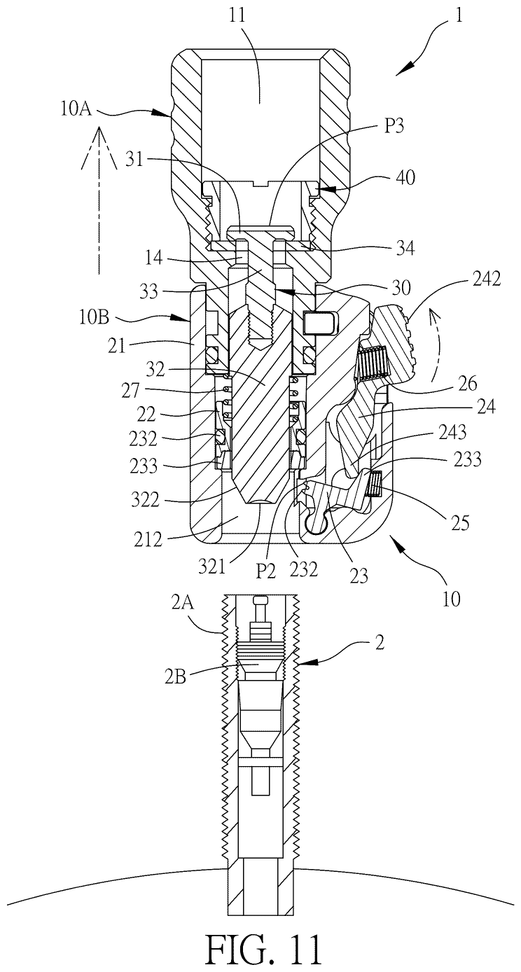

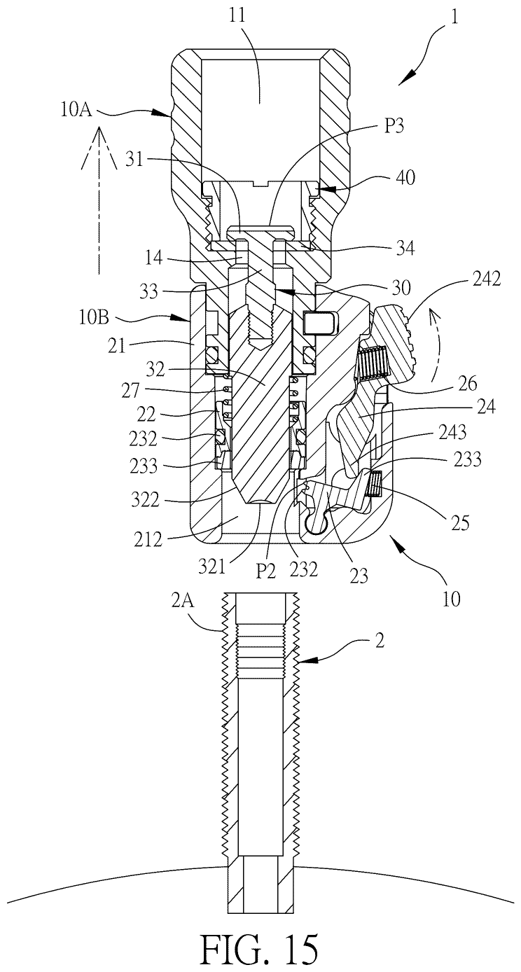

In this embodiment, a movable retainer 23 is provided and is rotatably connected in the cavity 21C of the connector 21 proximate to the second fixing orifice 212, wherein the movable retainer 23 has a second rotatable portion 231 formed on a side thereof and rotatably connected with the first rotatable connection portion 215 of the connector 21, a tooth portion 232 formed on an inner wall of the movable retainer 23, and an actuation portion 233 formed on an outer wall of the movable retainer 23, wherein the tooth portion 232 is controlled to move between an internal position P1 (as shown in FIGS. 4, 8 and 12) and an external position P2 (as illustrated in FIGS. 11 and 15), wherein the internal position P1 is located in the second fixing orifice 212, and the external position P2 is located outside the second fixing orifice 212 and in the cavity 21C.

In this embodiment, a control element 24 is provided and is located in the cavity 21C of the connector 21, wherein the control element 24 includes a fourth rotatable connection portion 241 and rotatably connected with the third rotatable connection portion 216 of the connector 21, wherein the control element 24 includes a manual operation portion 242 extending from an outer wall thereof and configured to be controlled manually, a controlled portion 243 formed on an inner wall of the control element 24 and configured to mate with the actuation portion 233 of the movable retainer 23, such that after the manual operation portion 242 is pressed manually, the controlled portion 243 actuates the actuation portion 233 of the movable retainer 23 to move outward so that the tooth portion 232 of the movable retainer 23 moves to the external position P2 from the internal position P1.

In this embodiment, two return parts 25, 26 are provided, wherein the two return parts 25, 26 are respectively configured to abut against and between the connector 21, the movable retainer 23, and the control element 24. The tooth portion 232 of the movable retainer 23 is normally located in the internal position P1, and when pressing the manual operation portion 242 of the control element 24, the two return parts 25, 26 are pressed to push the actuation portion 233 of the movable retainer 23 so that the tooth portion 232 of the movable retainer 23 is moved to the external position P1. In this embodiment, the two return parts 25, 26 are a spring.

The force spring 27 is accommodated in the channel 213 of the connector 21 and is defined between the coupling portion 13 of the first connection element 10A and the stop ring 22, wherein the force spring 27 pushes the stop ring 22 to the second fixing orifice 212.

The protrusion 214 is one-piece injection molded with the cap 21B, when the cap 21B is connected with the seat 21A, the protrusion 214 is engaged in the defining groove 132 of the coupling portion 13, and the coupling portion 13 of the first connection element 10A, the stop ring 22, the movable retainer 23, the control element 24, the two return parts 25, 26 and the force spring 27 are fixed in the connector 21.

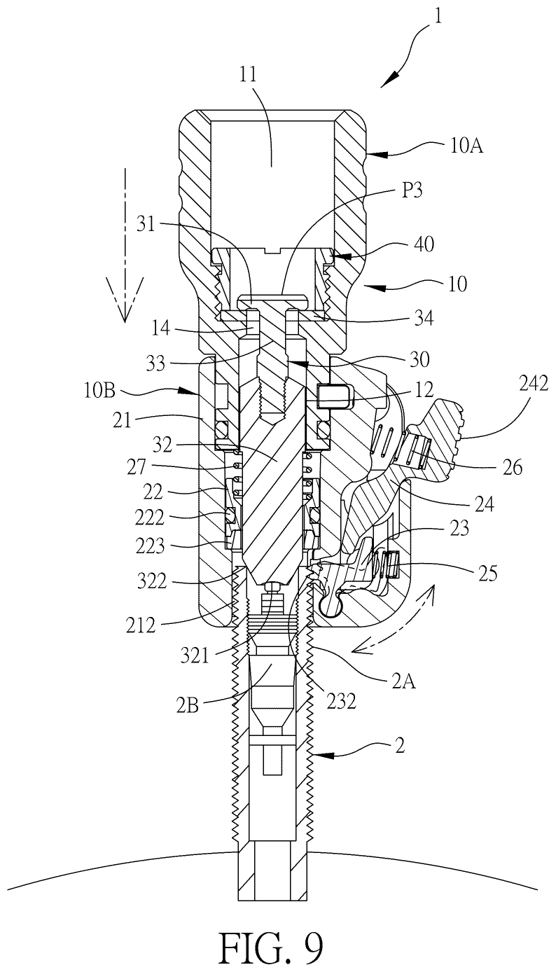

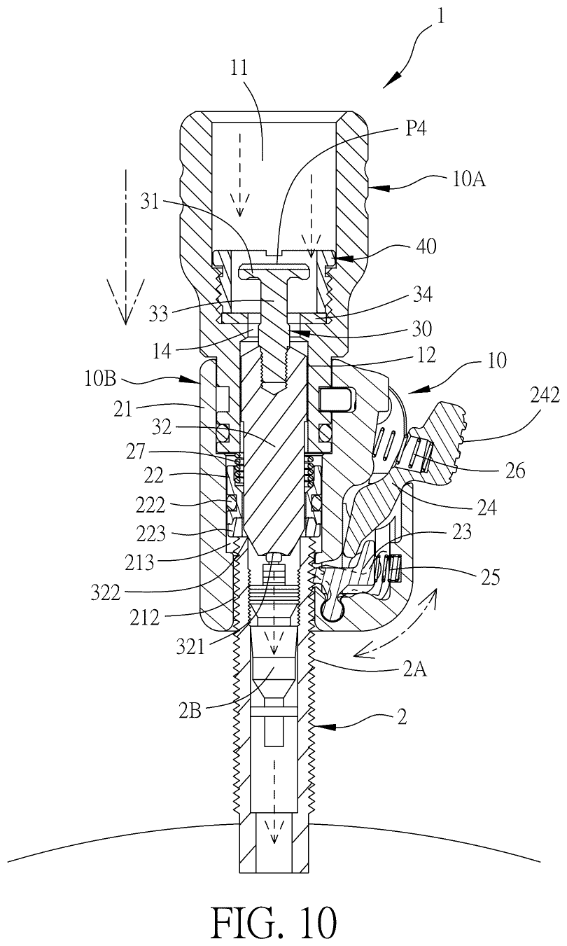

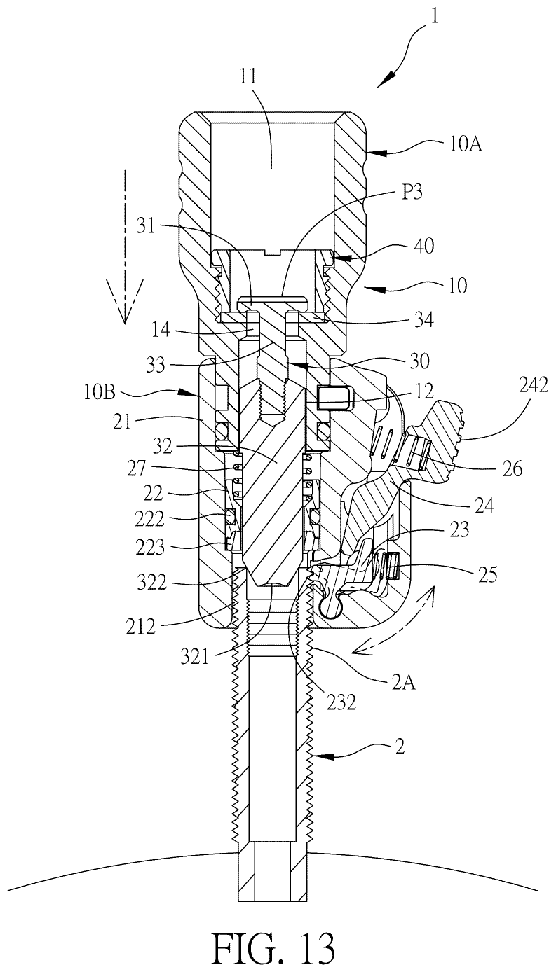

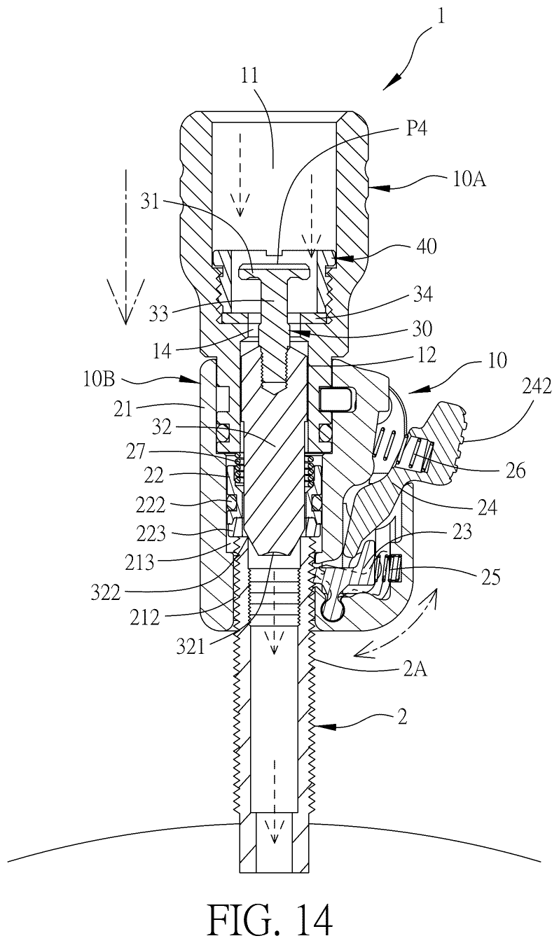

The needle valve 30 is received in the first connection element 10A and the connector 21, the needle valve 30 includes a close portion 31 formed on a first end thereof, a post 32 formed on a second end of the needle valve 30, a locating rod 33 defined between the close portion 31 and the post 32, wherein a cross-section of the post 32 is non-circular, and the post 32 has a contact portion 321 and a pushed portion 322 which are formed on an end thereof of the post 32 away from the locating rod 33, wherein the close portion 31 is accommodated in the air feeding chamber 11 of the first connection element 10A, an air block element 34 is mounted between the close portion 31 and the air feeding chamber 11, the close portion 31 abuts against the air block element 34 to close the conduit 14, the post 32 is inserted through the air feeding chamber 11 of the first connection element 10A and channel 213 of the connector 21 and does not block the air feeding chamber 11 and the channel 213. The locating rod 33 is inserted through the conduit 14 of the first connection element 10A, and the close portion 31 has a close portion diameter 31A, the post 32 has a post width 32A, the contact portion 321 has a width 321A, and the locating rod 33 has a locating rod diameter 33A, wherein the close portion diameter 31A of the close portion 31 and the post width 32A are greater than the conduit diameter 14A, and the locating rod diameter 33A is smaller than the diameter 14A of the conduit 14 so as to produce a limitation effect. For example, the needle valve 30 is limited to move between a closing position P3 (as shown in FIGS. 4, 8, 9, 11-13 and 15) and an opening position P4 (as shown in FIGS. 10 and 14), wherein the width 321A of the contact portion 321 is smaller than the internal diameter 2C of the inflation head 2, the post width 32A is greater than the internal diameter 2C of the inflation head 2 and is smaller than the external diameter 2D of the inflation head 2. In this embodiment, the close portion 31 is one-piece formed with the locating rod 33, the post 32 is screwed with the locating rod 33, and the pushed portion 322 is conical.

The abutting ring 40 includes an external threaded section 41 formed on an outer wall thereof and is received in the air feeding chamber 11 of the first connection element 10A so that the external threaded section 41 is screwed with the inner threaded section 111 of the air feeding chamber 11, and abutting ring 40 abuts against the air block element 34.

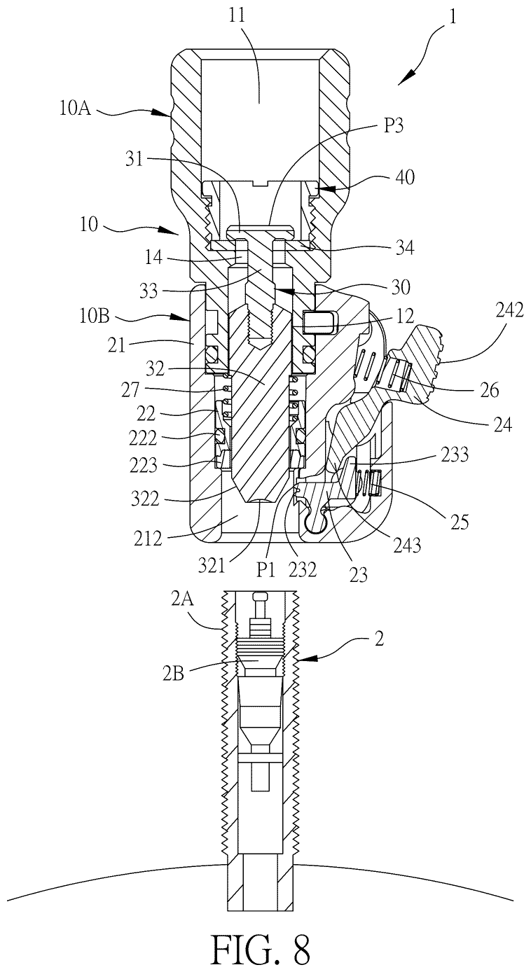

When inflating air into the inflation head 2 by using the tire valve 1, as shown in FIGS. 8-10, inflating equipment is communicated with the air feeding chamber 11 of the first connection element 10A. In the meantime, the needle valve 30 is located in the closing position P3, the close portion 31 mates with the air feeding chamber 11 to abut against the air block element 34, thus closing the conduit 14. The second fixing orifice 212 of the connector 21 of the second connection element 10B is fitted on the inflation head 2 so that an edge of the inflation head 2 is inserted into the second fixing orifice 212 with the user's one hand easily. During inserting the inflation head 2, the tooth portion 232 of the movable retainer 23 is forced by the external threads 2A to mate with the two return parts 25, 26 to move between the internal position P1 and the external position P2, thus obtaining an automatic engagement so that the inflation head 2 is inserted into a predetermined position (a part of the inflation head 2 enters into the channel 213 of the connector 21). Then, the valve core 2B of the inflation head 2 is forced by the contact portion 321 to turn on, wherein an open end of the inflation head 2 abuts against the pushed portion 322, the tooth portion 232 of the movable retainer 23 automatically engages with the external threads 2A of the inflation head 2 securely, and the edge of the inflation head 2 abuts against the stop ring 22 to press the force spring 27 so as to produce the airtight sealing effect between the edge of the inflation head 2 and the second airtight sealing portion 223 of the stop ring 22, and the inflation head 2 pushes the needle valve 30 to the opening position P4 so that the close portion 31 of the needle valve 30 moves away from an inner wall of the air feeding chamber 11, hence the conduit 14 is not closed so that the inflation head 2 is communicated with the air feeding chamber 11 of the first connection element 10A, thus inflating the air into the inflation head 2 by using the inflating equipment automatically. Thereafter, the inflation head 2 is used to inflate the air into the tire (not shown) automatically after being inserted into the tire (not shown) from the second fixing orifice 212.

After inflating the air into the tire (not shown), as shown in FIG. 11, the manual operation portion 242 of the control element 24 is pressed with one hand so that the control element 24 presses the return part 26, wherein the controlled portion 243 of the control element 24 rotates along the fourth rotatable connection portion 241 so as to push the actuation portion 233 of the movable retainer 23 in a leverage manner, and the movable retainer 23 urges the force spring 27, wherein the tooth portion 232 of the movable retainer 23 rotates along the second rotatable connection portion 231 so as to move to the external position P2 from the internal position P1, and the tire valve 1 disengages from the inflation head 2, thus removing the tire valve 1 from the inflation head 2.

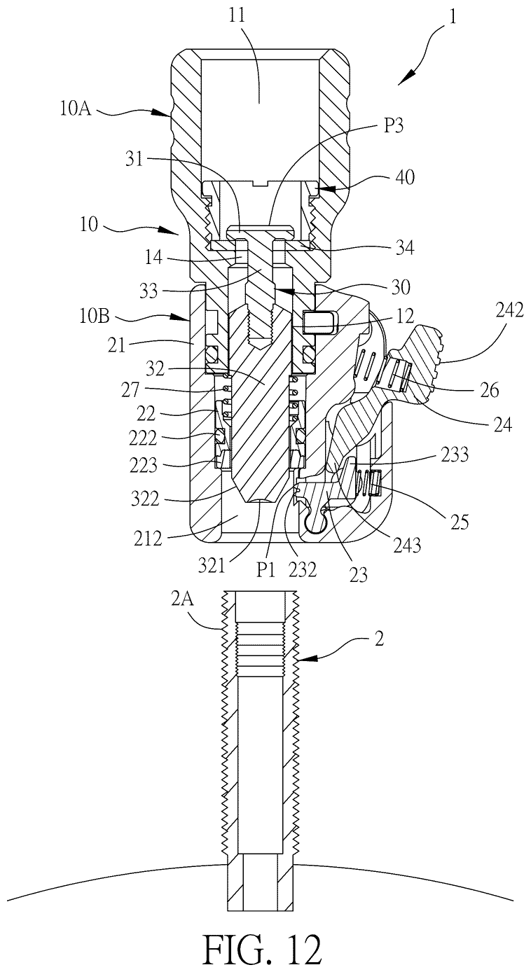

The tire valve 1 is configured to inflate the air into the inflation head 2 without connecting with the valve core 2B, as shown in FIGS. 12-15. Such an operation is a well-known art, so further remarks are omitted.

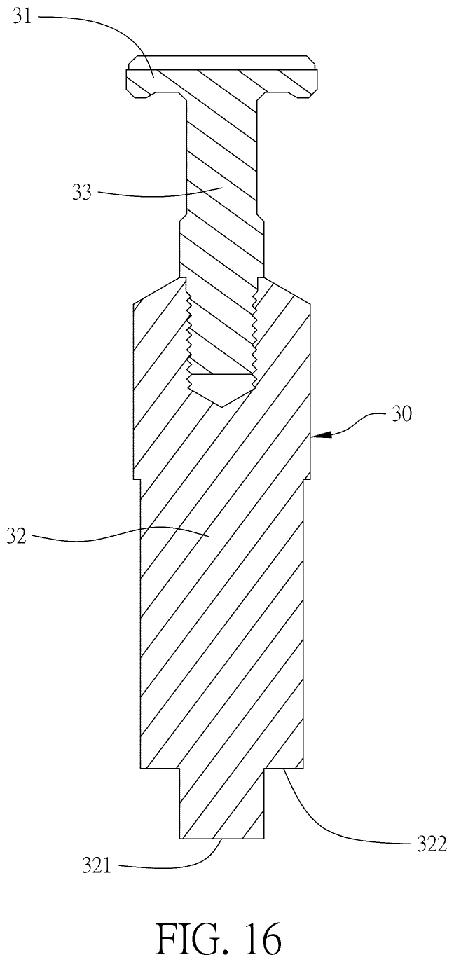

In another embodiment, as shown in FIG. 16, the pushed portion 322 of the needle valve 30 is plane.

Therefore, the tire valve 1 of the present invention has advantages as follows:
1) The tire valve 1 is connected with the inflation head 2 of the tire (not shown) and is removed from the inflation head 2 with one hand easily, when inflating/deflating the air into/from the tire (not shown). The tire valve 1 is connected with the inflation head 2 in an automatic engagement manner, thus inflating the air quickly and easily to save operation time and labor.
2) The close portion 31 mates with the air feeding chamber 11 to abut against the air block element 34 so as to produce the airtight sealing effect, thus preventing an air leakage from the tire valve 1 and enhancing using convenience, when connecting the tire valve 1 with the inflation head 2.
3) The tire valve 1 is applicable for the inflation head with/without the valve core 2B to inflate the air quickly and strongly.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A tire valve (1) capable of engaging and inflating automatically is configured to inflate air into a tire via an inflation head (2), the inflation head (2) includes external threads (2A) formed on an outer wall of the inflation head (2), an internal diameter (2C) and an external diameter (2D), the tire valve (1) comprising:
a body (10) includes a first connection element (10A) and a second connection element (10B);
wherein the first connection element (10A) includes an air feeding chamber (11), and the second connection element (10B) includes a connector (21), a stop ring (22), at least one movable retainer (23), and at least one return part (25);
wherein the connector (21) is connected with the first connection element (10A), and the connector (21) includes a second fixing orifice (212) formed on a first end thereof, a conduit (14) is defined between the second fixing orifice (212) and the air feeding chamber (11), an air discharge chamber (12) is communicated with a channel (213), the conduit (14) has a conduit diameter (14A), and the second fixing orifice (212) is configured to accommodate the inflation head (2);
wherein the stop ring (22) is received in the channel (213) and does not stop the channel (213), the stop ring (22) includes a second fixing orifice (221) defined therein, and the stop ring (22) also includes a second airtight sealing portion (223) formed thereon and facing the second fixing orifice (212);
wherein the movable retainer (23) is rotatably connected with an end of the connector (21) adjacent to the second fixing orifice (212), and the movable retainer (23) includes a tooth portion (232) formed on an inner wall thereof, and an actuation portion (233) formed on an outer wall of the movable retainer (23), wherein the tooth portion (232) is controlled to move between an internal position (P1) and an external position (P2), the internal position (P1) is located in the second fixing orifice (212), and the external position (P2) is located outside the second fixing orifice (212);
wherein the at least one return part (25) is configured to abut against the movable retainer (23) so that the tooth portion (232) of the movable retainer (23) is normally located in the internal position (P1), and when controlling the actuation portion (233), the tooth portion (232) of the movable retainer (23) is moved to the external position (P2); and
wherein a needle valve (30) is received in the first connection element (10A) and the connector (21), the needle valve (30) includes a close portion (31) formed on a first end thereof, a post (32) formed on a second end of the needle valve (30), a locating rod (33) defined between the close portion (31) and the post (32), wherein the post (32) has a contact portion (321) and a pushed portion (322) which are formed on an end of the post (32) away from the locating rod (33), wherein the close portion (31) is accommodated in the air feeding chamber (11), an air block element (34) is mounted between the close portion (31) and the air feeding chamber (11), the close portion (31) abuts against the air block element

(34) to close the conduit (14), the post (32) is inserted through the air feeding chamber (11) and the channel (213) and does not block the air feeding chamber (11) and the channel (213); the locating rod (33) is inserted through the conduit (14), and the close portion (31) has a close portion diameter (31A), the post (32) has a post width (32A), the contact portion (321) has a contact portion width (321A), and the locating rod (33) has a locating rod diameter (33A), wherein the close portion diameter (31A) and the post width (32A) are greater than the conduit diameter (14A), and the locating rod diameter (33A) is smaller than the conduit (14A) diameter so as to produce a limitation effect, the needle valve (30) is limited to move between a closing position (P3) and an opening position (P4), wherein the contact portion width (321A) is smaller than the internal diameter (2C) of the inflation head (2).

2. The tire valve as claimed in claim 1, wherein first connection element (10A) and the connector (21) are respectively an independent component, the first connection element (10A) includes a coupling portion (13) defined on a second end thereof opposite to the air feeding chamber (11), the connector (21) has a first fixing orifice (211) defined thereon opposite to the second fixing orifice (212) and configured to accommodate the coupling portion (13) of the first connection element (10A).

3. The tire valve as claimed in claim 2, wherein the connector (21) further has a protrusion (214) accommodated in the channel (213), the coupling portion (13) of the first connection element (10A) has an O ring (131) engaged on an outer wall thereof, and the coupling portion (13) has a defining groove (132) formed in an annular shape and on the outer wall thereof, wherein an inner wall of the first fixing orifice (211) contacts with the O ring (131) of the coupling portion (13) to produce an airtight sealing effect, and the protrusion (214) is engaged in the defining groove (132) so that the connector (21) is rotatable but is not removable respect to the first connection element (10A).

4. The tire valve as claimed in claim 1, wherein the second connection element (10B) includes at least one control element (24) which is rotatably connected with the connector (21) and is forced by the at least one return part (26), wherein the control element (24) includes an manual operation portion (242) extending from an outer wall thereof and configured to be controlled manually, a controlled portion (243) formed on an inner wall of the control element (24) and configured to mate with the actuation portion (233) of the movable retainer (23), such that after the manual operation portion (242) is pressed manually, the controlled portion (243) actuates the actuation portion (233) of the movable retainer (23) to move outward so that the tooth portion (232) of the movable retainer (23) moves to the external position (P2) from the internal position (P1).

5. The tire valve as claimed in claim 1, wherein the second connection element (10B) includes a force spring (27) accommodated in the channel (213) thereof and configured to push the stop ring (22) to the second fixing orifice (212).

6. The tire valve as claimed in claim 3, wherein the connector (21) includes a seat (21A), a cap (21B) connected with the seat (21A), and a cavity (21C) defined between the seat (21A) and the cap (21B), wherein the protrusion (214) is one-piece injection molded with the cap (21B), when the cap (21B) is connected with the seat (21A), the coupling portion (13) of the first connection element (10A), the stop ring (22), the movable retainer (23), and the two return parts (25) are fixed in the connector (21).

7. The tire valve as claimed in claim 1 further comprises an abutting ring (40), wherein the air feeding chamber (11) of the first connection element (10A) has an inner threaded section (111), the abutting ring (40) includes an external threaded section (41) formed on an outer wall thereof, and the abutting ring (40) is received in the air feeding chamber (11) of the first connection element (10A) so that the connection element (10A) is screwed with the inner threaded section (111) of the air feeding chamber (11), and the abutting ring (40) abuts against the air block element (34).

8. The tire valve as claimed in claim 1, wherein the close portion (31) is one-piece formed with the locating rod (33), and the post (32) is screwed with the locating rod (33).

9. The tire valve as claimed in claim 2, wherein the stop ring (22) is moved to the first fixing orifice (211) or the second fixing orifice (212) in the channel (213), and the stop ring (22) has a first airtight sealing portion (222) formed on an outer wall thereof.

10. The tire valve as claimed in claim 1, wherein the post width (32A) is greater than the internal diameter (2C) of the inflation head (2) and is smaller than the external diameter (2D) of the inflation head (2).
